(19) United States
(12) Patent Application Publication
(10) Pub. No.: US 2007/0009399 A1
(43) Pub. Date: Jan. 11, 2007

(54) Metal core auto exhaust purifier

(76) Inventor: Rongkang Liu, Hangzhou (CN)

Correspondence Address: LIU, Rongkang, #670, 17800 Castleton Street, City of Industry, CA, 91748, US

(21) Appl. No.: 11/174,591

(22) Filed: Jul. 6, 2005

(51) Int. Cl. B01D 53/34; B01D 50/00

(52) U.S. Cl. 422/168; 422/171

(57) ABSTRACT

A metal core auto exhaust purifier adopts a metal core as a key component in an auto exhaust purifier. The metal core is resistant to vibration and thermal shock, can immediately purify auto exhaust without heating process, has much longer working life, enhances catalyst's adhesion, prolongs catalyst's working life, and improves the effect of auto exhaust purification.

### BACKGROUND

This invention relates to automobile exhaust purification, more specifically, to an automobile exhaust purifier attached to automobile engine from outside. The purification improves and purifies the noxious gas (CO, HC, and NO x) discharged from a working automobile engine, in order to reduce the pollution on the environment by auto exhaust.

The automobile exhaust is first purified inside the engine (electric-spraying). When being discharged into the air, the exhaust is then further purified by a purifier attached to the engine from outside. The key component of a purifier is its core.

Currently, all automobile exhaust purifiers adopt a ceramic core. The ceramic core is weak in strength, i.e., it lacks good capacity of resisting thermal shock generated by automobile engines. Consequently, a ceramic core is susceptible to vibration of automobiles and easy to break, resulting in loss of its purifying function.

Further, during the process of manufacturing, a ceramic core, limited by the technology, can only be made to contain 400 holes per square inch at most which limits its side purifying area and results in larger size, low thermal conduction and high thermal capacity.

### SUMMARY

This invention adopts a metal core, instead of a ceramic one, in an automobile exhaust purifier.

A metal core is resistant to vibration or thermal shock of a moving automobile resulting in longer life of a purifier. The metal core has better thermal conducting performance than a ceramic one and thus can achieve same efficiency of purification with smaller size. The metal core, by enhancing adhesion of catalyzers, prolongs catalyzers' service life and improves the purifying effect on noxious exhaust discharged by automobiles.

### DRAWINGS

The features, aspects and structures of this invention will become better understood with reference to the following description, appended claims, and accompanying drawings where:

FIG. 1 is a view of vertical section of the auto exhaust purifier with the metal core 4;

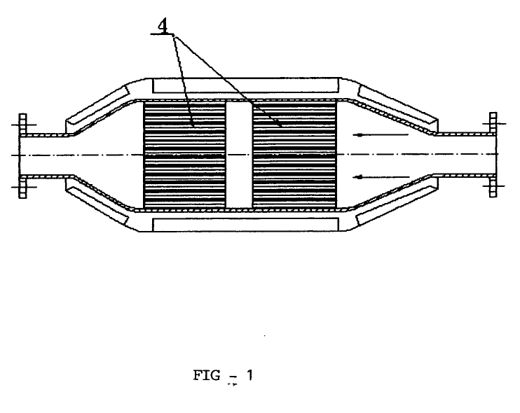

FIG. 2 is a view of transverse section of the auto exhaust purifier with the metal core 4;

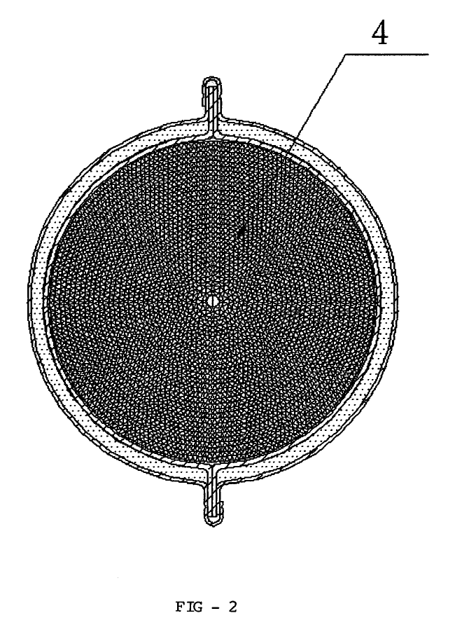

FIG. 3 show the structure of the plate body comprising of locating plates 1, axial corrugated plates 2, and bearing grooves 3.

### DESCRIPTIONS

This invention may have four (4) different implementing modes.

Mode 1:

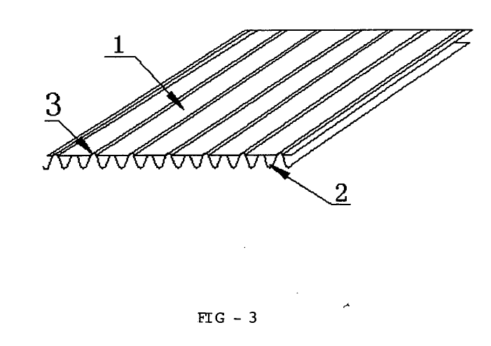

A metal core comprises: (1) locating plates 1 with bearing grooves 3; and (2) axial corrugated plates 2. Both locating plates 1 and axial corrugated plates 2 are made of special type of stainless steel sheet (ferrite). Locating plates 1 pile with axial corrugated plates as shown from FIG. 3.

The axial corrugated plate 2 is a plate with sequential undulating corrugation. The wave cycle length of the corrugation is 3 mm and the amplitude is 1.8 mm.

The locating plate 1 has bearing grooves 3. The bearing grooves 3 parallel one another at a distance of 6 mm which is integral multiple of wave cycle length of the axial corrugated plate.

The wave crest of axial corrugated plate 2 inlays the groove of locating plate 1, constituting a plate body. This plate body forms a column core by winding compatible to the size of the purifiers.

This implementing mode 1 is the best mode of operation of the invention contemplated by the inventor.

Mode 2:

This mode is identical to Mode 1 in all aspects, except that the distance between the paralleling groove of locating plate 1 is 9 mm.

Mode 3:

This mode is identical to Mode 1 in all aspects, except that the column core 4 is in the shape of elliptic cylinder.

Mode 4:

This mode is identical to Mode 1 in all aspects, except that the column core 4 is a square-shaped cylinder.

What is claimed is:

1. A metal core of auto exhaust purifier comprises of (1) locating plates 1 with bearing grooves 3; and (2) axial corrugated plates 2, made of special type of stainless steel sheet (ferrite). It features that axial corrugated plates 2 are with sequential undulation corrugation; locating plates are with bearing grooves paralleling one another at a certain spacing distance; the distance is the integral multiple of the wave cycle length of axial corrugated plates 2; the wave crests of axial corrugated plates corresponding to the grooves of locating plates inlay the grooves of locating plates constituting a plate body; and this plate body is wound into a column core compatible with the cross section of the purifiers.

2. The metal core of claim 1 may be in the shape of a cylinder core.

3. The metal core of claim 1 may be in the shape of a elliptic column core.

4. The metal core of claim 1 may be a square-shaped column core.
